(19) United States
(12) Patent Application Publication
(10) Pub. No.: US 2013/0135200 A1
(43) Pub. Date: May 30, 2013

(54) Electronic Device and Method for Controlling Same

(71) Applicant: Futoshi Iwashita, Kanagawa (JP)

(72) Inventor: Futoshi Iwashita, Kanagawa (JP)

(73) Assignee: KYOCERA CORPORATION, Kyoto (JP)

(21) Appl. No.: 13/814,863

(22) PCT Filed: Aug. 9, 2011
(86) PCT No.: PCT/JP2011/068119

§ 371 Date: Feb. 7, 2013

(30) Foreign Application Priority Data
Aug. 11, 2010 (JP) 2010-180640

(51) Int. Cl. G06F 3/01

(52) U.S. Cl. CPC G06F 3/01
USPC 345/156

(57) ABSTRACT

Provided is an electronic device whereby input characters can be used in a desired application by a simple operation, and a method for controlling the electronic device. While on screen, if a leftward shaking operation is detected again by a motion sensor, a control unit displays, instead of the screen of a notepad application, a browser application screen of a browser application different from the notepad application. While on screen, if a detecting unit detects the operation of a user's finger being lifted from the surface of a display unit, the control unit inputs the input text “BOU-SUI MOBILE”, displayed on the display unit, in a search box on the browser application and launches the browser application.

### TECHNICAL FIELD

The present invention relates to an electronic device and a method for controlling the same.

### BACKGROUND ART

Conventionally, in an electronic device having a display unit and an operation unit, when the operation unit is operated in a state where a standby screen is displayed on the display unit, characters assigned to the operation unit are input and displayed on the display unit. Moreover, by selecting a desired application among menu items of a plurality of applications in a state where input text is displayed on the display unit, the electronic device starts the selected application with the displayed text being input into the application (for example, refer to Patent Document Patent Document 1: Japanese Unexamined Patent Application, Publication No. 2007-200243

### DISCLOSURE OF THE INVENTION

### Problems to be Solved by the Invention

However, when starting a desired application in the electronic device described in Patent Document 1, the user needs to select one application among the menu items of a plurality of applications and perform a plurality of operations.

An object of the present invention is to provide an electronic device that can use input text for a desired application with a simple operation and a method for controlling the same.

### Means for Solving the Problems

An electronic device according to the present invention comprises: a display unit which displays images corresponding to a plurality of functions capable of inputting text; and a control unit which, when a first operation is detected in a state where a first image corresponding to a first function among the plurality of functions is displayed or selected, causes to display or select a second image corresponding to a second function that is different from the first function among the plurality of functions instead of the first image; and wherein in a state where the second image is displayed or selected, when a second operation different from the first operation is detected or a state where an operation is not detected continues for more than or equal to a predetermined time period, the control unit starts the second function with input text being input into the second function.

In addition, it is preferable if the electronic device further comprises an operation unit, and the input text is text displayed on the display unit immediately before the first image is displayed or selected.

In addition, it is preferable if, when the first operation is detected in a state where a first screen corresponding to the start of the first function is displayed on the display unit as the first image, the control unit causes to display a second screen corresponding to the start of the second function on the display unit as the second image, and when the second operation is detected or a state where an operation is not detected continues for more than or equal to a predetermined time period in a state where the second screen is displayed, the control unit causes to start the second function with the input text being input into the second function.

In addition, it is preferable if, when the first operation is detected in a state where a first icon for starting the first function is selected as the first image, the control unit causes to select a second icon for starting the second function as the second image, and in a state where the second icon is selected, when the second operation is detected or a state where an operation is not detected continues for more than or equal to a predetermined time period, the control unit causes to start the second function with the input text being input into the second function.

In addition, it is preferable if, in a state where the second image is displayed or selected, the control unit causes to start the second function only when the second operation is detected or a state where an operation is not detected continues for more than or equal to a predetermined time period.

In addition, it is preferable if the first operation is an operation of shaking a body of the electronic device toward a predetermined direction, and the control unit causes to change an order of displaying the first image and the second image on the display unit according to the direction the body of the electronic device is shaken.

In addition, it is preferable if the first operation is an operation of sliding the display unit, and the control unit causes to change an order of displaying the first image and the second image on the display unit according to the direction the display unit is slid.

In addition, it is preferable if the operation unit includes a plurality of operation keys to which a character and a number are assigned to one operation key, and in a state where a standby screen is displayed on the display unit, when one of the operation keys is operated among the plurality of operation keys, the control unit causes to respectively input the character and the number assigned to the operation key and display the character and the number on the display unit, and change an order of displaying the first image and the second image on the display unit according to which of the displayed text or number is input as the input text.

A method for controlling an electronic device according to the present invention comprises: a step of displaying or selecting a first image corresponding to a first function among a plurality of functions; a step which, when a first operation is detected, displays or selects a second image corresponding to a second function that is different from the first function among the plurality of functions instead of the first image; and a step which, in a state where the second image is displayed or selected, when a second operation different from the first operation is detected or a state where an operation is not detected continues for more than or equal to a predetermined time period, starts the second function with input text being input into the second function.

### Effects of the Invention

According to the present invention, it is possible to provide an electronic device that can use input text for a desired application with a simple operation and a method for controlling the same.

### BRIEF DESCRIPTION OF THE DRAWINGS

FIG. 1 is an external perspective view of a mobile telephone device according to an embodiment;

FIG. 2 is a block diagram showing a functional arrangement of the mobile telephone device according to an embodiment;

FIG. 3 is a diagram showing an example of screen transfers displayed on a display unit according to a first embodiment;

FIG. 4 is a flow chart (1) showing internal processing of the example shown in FIG. 3;

FIG. 5 is a flow chart (2) showing internal processing of the example shown in FIG. 3;

FIG. 6 is a diagram showing an example of the screen transfer displayed on the display unit according to a second embodiment;

FIG. 7 is a flow chart (1) showing internal processing of the example shown in FIG. 6;

FIG. 8 is a flow chart (2) showing internal processing of the example shown in FIG. 6;

FIG. 9 is a diagram showing an example of the screen transfer displayed on the display unit according to a third embodiment; and

FIG. 10 is a flow chart showing internal processing of the example shown in FIG. 9.

### PREFERRED MODE FOR CARRYING OUT THE INVENTION

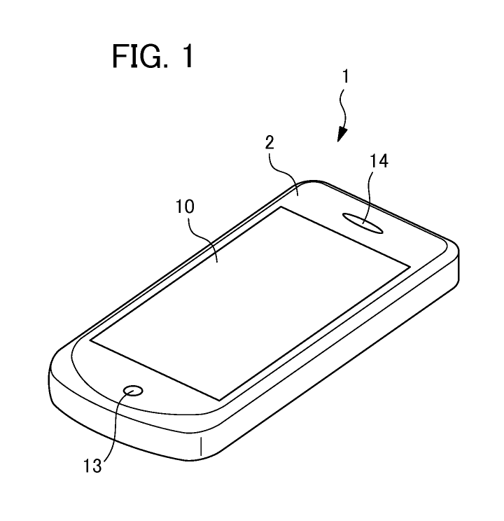

Embodiments of the present invention will be described now. First, a basic structure of a mobile telephone device 1 according to an embodiment of an electronic device according to the present invention will be described with reference to FIG. 1. FIG. 1 is an external perspective view of the mobile telephone device 1 according to the embodiment.

The mobile telephone device 1 has a housing 2. The housing 2 has a touch panel 10 (operation unit), a microphone 13, and a speaker 14.

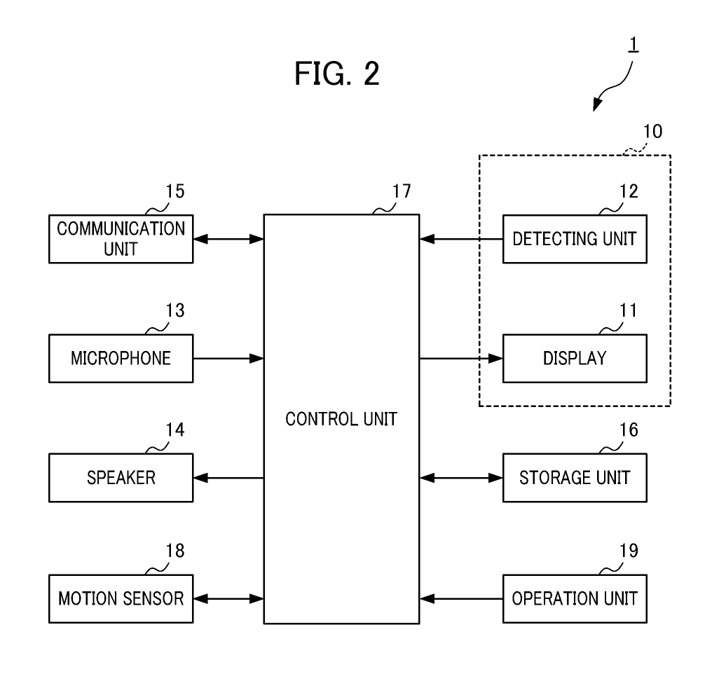

The touch panel 10 has a display unit 11 and a detecting unit 12 (refer to FIG. 2). The display unit 11 is, for example, a liquid crystal display panel or an organic EL (electroluminescence) display panel. The detecting unit 12 is a sensor that detects contact of an object, such as a finger of the user of the mobile telephone device 1 and a touch pen, to the display unit 11. A sensor of a type of, for example, capacitive sensing type and resistance film type, arranged correspondingly to the surface of the display unit 11 can be used for the detecting unit 12.

The microphone 13 is used for inputting sound that the user of the mobile telephone device 1 utters at the time of a telephone call. The speaker 14 is used for outputting sound that the other party of the call of the user of the mobile telephone device 1 utters.

The functional arrangement of the mobile telephone device 1 according to an embodiment of the present invention will be described with reference to FIG. 2. FIG. 2 is a block diagram showing a functional arrangement of the mobile telephone device 1 according to the embodiment.

The mobile telephone device 1 has the touch panel 10 (the display unit 11 and the detecting unit 12), the microphone 13, and the speaker 14, which are described above. In addition, the mobile telephone device 1 has a communication unit 15, a storage unit 16, a control unit 17, a motion sensor 18, and an operation unit 19.

The communication unit 15 has a main antenna (not illustrated) and an RF circuit unit (not illustrated) and initiates communication to and communicates with certain contact parties. Contact parties to which the communication unit 15 transmits are emergency contact parties, such as the police and fire fighting authorities, for example. In addition, examples of the communication destination with which the communication unit 15 communicates include an external device that transmits and receives telephone calls and mails to and from the mobile telephone device 1, and an external device of an external web server or the like to which the mobile telephone device 1 connects via the Internet.

The communication unit 15 communicates with external devices using a predetermined frequency band. Specifically, the communication unit 15 demodulates the signal received with the main antenna and supplies the signal thus processed to the control unit 17. In addition, the communication unit 15 modulates the signal supplied from the control unit 17 and transmits the signal to an external device (base station) via the main antenna.

The storage unit 16 includes, for example, a working memory, and is used for arithmetic processing by the control unit 17. In addition, the storage unit 16 stores one or more of applications and databases that run inside the mobile telephone device 1. It should be noted that the storage unit 16 may also include a detachable external memory.

The control unit 17 controls the entire mobile telephone device 1 and controls the display unit 11 and the communication unit 15. The motion sensor 18 is constituted by either of or a combination of, for example, an acceleration sensor, a gyro sensor, and an earth magnetism sensor. The motion sensor 18 detects displacement such as the position, the orientation, and the motion, of the mobile telephone device 1, and transmits it to the control unit 17.

The operation unit 19 can detect operations performed by a plurality of forms. For example, the operation unit 19 may be a virtual key (software key) displayed on the touch panel 10, or may be a physical key which is arranged separately on the housing 2 and to which, for example, a character, a number, or a symbol is assigned. For example, in a case where the operation unit 19 is a virtual key displayed on the touch panel 10, the operation unit 19 can detect operations performed by a plurality of forms, such as a contact operation and a sliding operation.

### First Embodiment

The mobile telephone device 1 according to the first embodiment has a function to start an application using text displayed on the display unit 11. Hereafter, the arrangement for performing the function will be described.

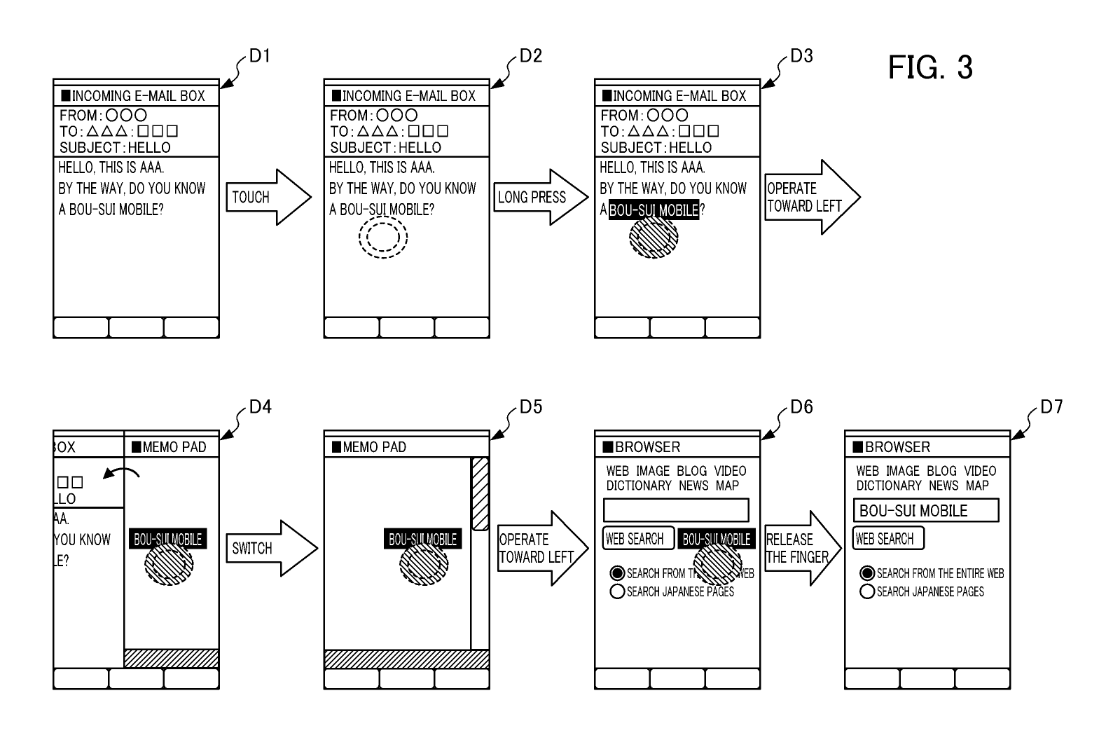

FIG. 3 is a diagram showing an example of the screen transfer displayed on the display unit 11 according to the first embodiment. In Screen D1 in FIG. 3, the control unit 17 displays a received mail on the display unit 11 by an electronic mail application. That is, the control unit 17 displays a plurality of characters by the electronic mail application. It should be noted that, in this specification, text includes not only a hiragana character, a katakana character and a kanji character but also a numerical character, an alphabetic character, and a symbol. In addition, “text” includes not only one character but also a character string. In addition, “number” includes not only a number but also text (for example, P (pause), - (hyphen), * (asterisk), and # (pound)) used for making a telephone call. In addition, “number” includes not only a single number but also a string of numbers.

In Screen D1, that is, in a state where text is displayed on the display unit 11, the control unit 17 selects “BOU-SUI MOBILE (”waterproof mobile“)” in response to the detecting unit 12 detecting (Screen D2) contact (long press) to the text “BOU-SUI MOBILE” among the text displayed on Screen D1. The text selected in the display unit 11 is displayed inverted (Screen D3).

In addition, the control unit 17 performs processing for starting Application A for editing input text in response to the input text “BOU-SUI MOBILE” being selected.

In Screen D3, in a case where the motion sensor 18 detects an operation (first operation) of shaking the body of the mobile telephone device 1 toward the left when seeing the display unit 11 from the front, the control unit 17 displays a screen (first image) of a memo pad application that corresponds to the memo pad application (first function) among a plurality of applications (a plurality of functions) stored in the storage unit 16 (Screens D4 and D5).

More specifically, when the motion sensor 18 detects an operation of shaking the body of the mobile telephone device 1 toward the left, the control unit 17 changes the screen from the screen of the electronic mail application to the initial screen of the memo pad application corresponding to the start of the memo pad application (Screen D4) and displays the initial screen of the memo pad application on the display unit (Screen D5).

In Screen D5, the control unit 17 continues the state where the input text “BOU-SUI MOBILE” is selected in Screen D3 and displays on the display unit 11 the selected input text “BOU-SUI MOBILE”. In addition, in Screen D5, when the state where the input text “BOU-SUI MOBILE” is selected is continuing, the control unit 17 may not start the memo pad application and display on the display unit 11 only the initial screen of the memo pad application, or may start the memo pad application and display on the display unit 11 the initial screen of the memo pad application.

Thereafter, in Screen D5, when the operation of shaking toward the left is detected again by the motion sensor 18, the control unit 17 displays an initial screen (second image) of a browser application corresponding to the browser application different from the memo pad application among a plurality of applications instead of the initial screen of the memo pad application (Screen D6).

More specifically, when the operation of shaking toward the left is detected again by the motion sensor 18, the control unit 17 changes the screen from the initial screen of the memo pad application to the initial screen of the browser application corresponding to the start of the browser application and displays the initial screen of the browser application on the display unit 11 (Screen D6).

In Screen D6, the control unit 17 continues the state where the input text “BOU-SUI MOBILE” is selected in Screen D3 and displays on the display unit 11 the selected input text “BOU-SUI MOBILE”. In addition, when the state where the input text “BOU-SUI MOBILE” is selected continues in Screen D6, the control unit 17 may display on the display unit 11 only the initial screen of the browser application without starting the browser application, or may display on the display unit 11 the initial screen of the browser application after starting the browser application.

Next, in Screen D6, when the detecting unit 12 detects release of the contact to the input text “BOU-SUI MOBILE” by the user's finger, that is, when the detecting unit 12 detects an operation (second operation) of releasing the user's finger from the surface of the display unit 11, the control unit 17 causes to input the input text “BOU-SUI MOBILE” displayed on the display unit 11 into a search box in the initial screen of the browser application and start the browser application (Screen D7).

In addition, in Screen D6, when the state where an operation is not detected continues for more than or equal to a predetermined time period instead of the detecting unit 12 detecting the operation (second operation) of releasing the user's finger from the surface of the display unit 11, the control unit 17 may start the browser application by inputting the input text “BOU-SUI MOBILE” displayed on the display unit 11 into the search box in the initial screen of the browser application (Screen D7).

Thus, according to the first embodiment, the mobile telephone device 1 can change the screen from the electronic mail application to the initial screen of the memo pad application or the browser application and causes to start the memo pad application or the browser application in the state where the text input on the display unit 11 is input into the memo pad application or the browser application. Therefore, in the mobile telephone device 1, it is possible to utilize the text input on the display unit 11 easily in an application that performs a desired function.

In addition, in the mobile telephone device 1, input text may be text selected according to the operation by the operation unit 19 among the text displayed on the display unit 11. Thereby, since the input text is the text selected according to an operation by the operation unit 19 in the mobile telephone device 1, it is possible to utilize the selected input text in a desired application easily and improve the operativity of the mobile telephone device 1.

In addition, in the state where the initial screen of the memo pad application or the browser application is displayed, when the operation of releasing the user's finger from the surface of the display unit 11 is detected by the detecting unit 12 or the state where an operation is not detected continues for more than or equal to a predetermined time period, the control unit 17 causes to start the memo pad application or the browser application corresponding to the initial screen of the memo pad application or the browser application displayed on the display unit 11 with the input text being input into the application.

That is, when the operation of shaking the body of the mobile telephone device 1 toward the left is detected, the mobile telephone device 1 changes the screen from the screen of the electronic mail application to the initial screen of the memo pad application, and when the operation of releasing the user's finger from the surface of the display unit 11 is detected or the state where an operation is not detected continues for more than or equal to a predetermined time period, the mobile telephone device 1 causes to start the memo pad application or the browser application corresponding to the initial screen of the memo pad application or the browser application. Thereby, the mobile telephone device 1 can start a desired application with the text being input into the application with intuitive operations.

In addition, in the state where the initial screen of the memo pad application or the browser application is displayed, the control unit 17 may start the memo pad application or the browser application by causing to input the text displayed on the display unit 11 as the input text only when the operation of releasing the user's finger from the surface of the display unit 11 is detected or the state where an operation is not detected continues for more than or equal to a predetermined time period. Accordingly, since the mobile telephone device 1 does not start the memo pad application or the browser application except for the case where the operation of releasing the user's finger from the surface of the display unit 11 is detected or the state where an operation is not detected continues for more than or equal to a predetermined time period, it is possible to prevent applications that are not intended to be started by the user from being started.

In addition, the control unit 17 may change the order of displaying on the display unit 11 the initial screens of the electronic mail application, the memo pad application, or the browser application according to the direction in which the mobile telephone device 1 body is shaken.

Specifically, every time the motion sensor 18 detects that the body of the mobile telephone device 1 is shaken toward the left, the control unit 17 changes the initial screens of the applications that are to be displayed on the display unit in the order of: initial screen (standby screen)->memo pad application->browser application->schedule application->electronic mail application->initial screen (standby screen)->. . .

Meanwhile, every time the motion sensor 18 detects that the body of the mobile telephone device 1 is shaken toward the right, the control unit 17 changes the initial screens of the applications that are to be displayed on the display unit 11 in the order of: initial screen (standby screen)->electronic mail application->schedule application->browser application->memo pad application->initial screen (standby screen)->. . . , that is, an order opposite to a case where the body is shaken toward the left.

Thus, since the mobile telephone device 1 changes the order of displaying the screens of the electronic mail application, the memo pad application, or the browser application on the display unit 11 according to the direction in which the mobile telephone device 1 body is shaken, it is possible to change the display of the screens of the electronic mail application, the memo pad application, or the browser application with intuitive operations.

In addition, the control unit 17 may change the order of displaying the screen of the electronic mail application, the memo pad application, or the browser application on the display unit 11 according to the direction in which the display unit 11 is slid.

Specifically, every time the detecting unit 12 detects that the finger slides the surface of the touch panel 10 toward the left, the control unit 17 changes the initial screens of the applications that are to be displayed on the display unit 11 in the order of: initial screen (standby screen)->memo pad application->browser application->schedule application->electronic mail application->initial screen (standby screen)->. . .

Meanwhile, every time the detecting unit 12 detects that the finger slides the surface of the touch panel 10 toward the right, the control unit 17 changes the initial screens of the applications that are to be displayed on the display unit 11 in the order of: initial screen (standby screen)->electronic mail application->schedule application->browser application->memo pad application->initial screen (standby screen)->. . . , that is, the order opposite to the case where the finger slides toward the left. In addition, the slide detected by the detecting unit 12 may be a slide of very short time (so-called a flick) or a slide more than or equal to a predetermined time (so-called a swipe). Alternatively, a slide may not be a sliding operation and may be an operation that merely contacts the surface of the touch panel 10, that is, a slide may be a touch operation.

Since the mobile telephone device 1 changes the order of displaying the first image and second image on the display unit according to the direction in which the display unit 11 is slid or the number of times contact is made with the display unit 11, it is possible to change the initial screen of the electronic mail application, the memo pad application, or the browser application with intuitive operations.

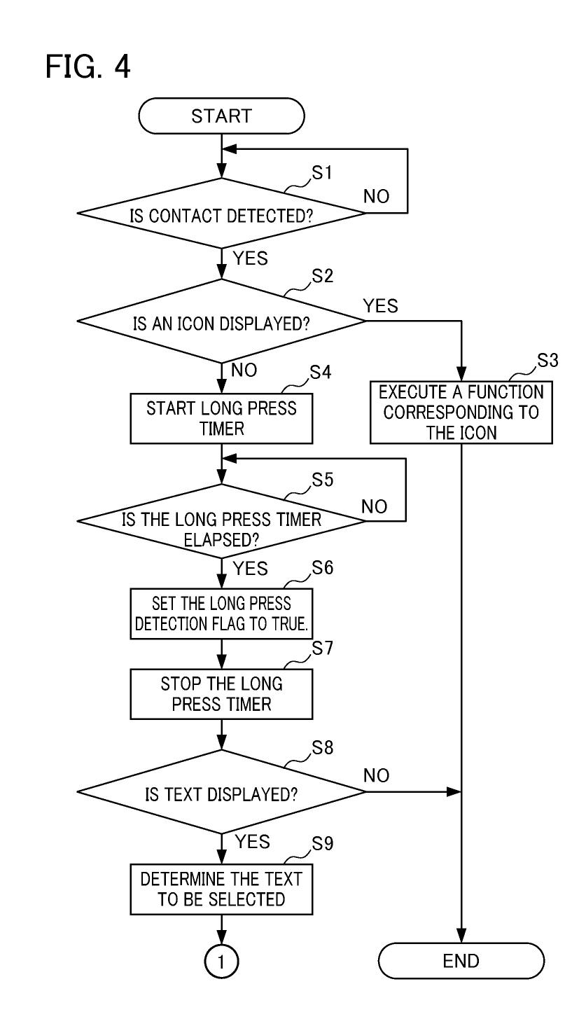

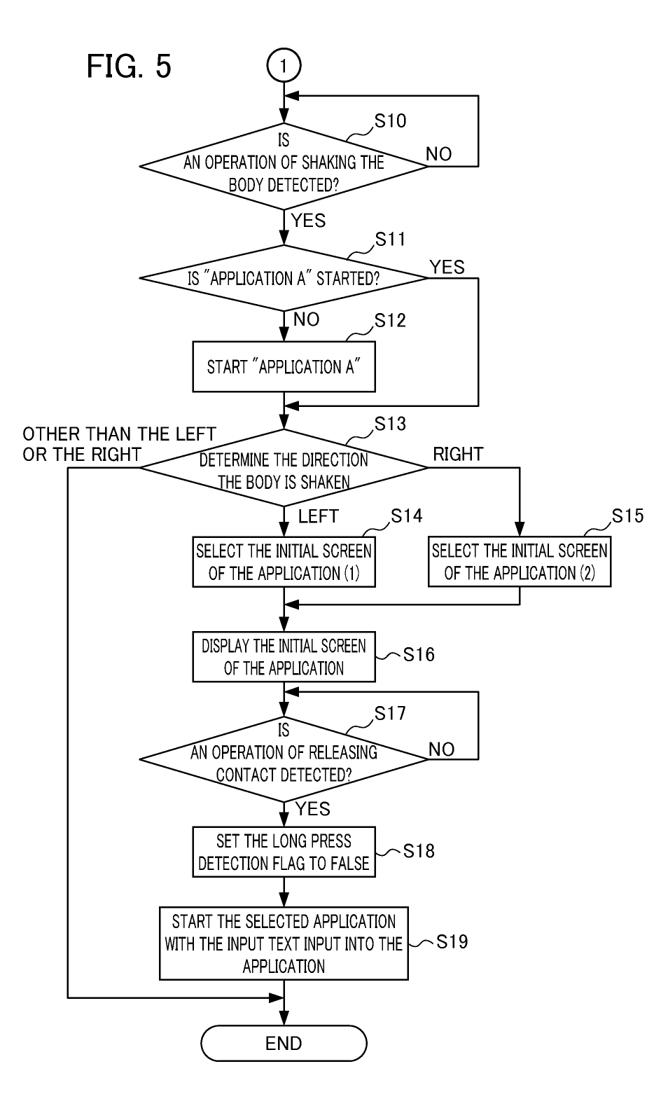

FIG. 4 and FIG. 5 are flow charts showing internal processing of the example shown in FIG. 3. It should be noted that it is assumed that text is displayed on the display unit 11 by a text input enabled application. In Step S1, the control unit 17 determines whether or not contact of the user's finger to the display unit 11 is detected by the detecting unit 12. If contact is detected (YES), the process proceeds to Step S2. If contact is not detected (NO), processing in Step S1 is repeated again.

In Step S2, the control unit 17 determines whether or not an icon is displayed on a location where the contact is detected by the detecting unit 12. If an icon is displayed on the location where the contact is detected (YES), the process proceeds to Step S3. When an icon is not displayed on the location where the contact is detected (NO), the process proceeds to Step S4.

In Step S3, the control unit 17 executes a function associated with the icon displayed on the location where the contact is detected in Step S2, the process ends. In Step S4, the control unit 17 starts measuring time by starting a long press timer.

In Step S5, the control unit 17 determines whether or not the contact to the display unit 11 detected by the detecting unit 12 has continued for a predetermined time period, that is, the control unit 17 determines whether or not the long press timer has elapsed. If the long press timer is elapsed (YES), the process proceeds to Step S6. If the long press timer is not elapsed (NO), processing in Step S5 is repeated again.

In Step S6, the control unit 17 sets the long press detection flag as “TRUE”. In Step S7, the control unit 17 stops the long press timer. In Step S8, the control unit 17 determines whether or not text is displayed on the location in the display unit 11 where the long press is detected. If text is displayed (YES), the process proceeds to Step S9. If text is not displayed (NO), the process ends.

In Step S9, the control unit 17 determines the text to be selected in a unit of sentence (or a unit of word, and a unit of character) and makes the selected text displayed inversely.

In Step S10, the control unit 17 determines whether or not the operation of shaking the body of the mobile telephone device 1 is detected by the motion sensor 18. If an operation of shaking the body of the mobile telephone device 1 is detected (YES), the process proceeds to Step S11. If the operation of shaking the body of the mobile telephone device 1 is not detected (NO), processing in Step S10 is repeated again. It should be noted that, in Step S10, the control unit 17 may also use as the condition a situation where the state where an operation is not detected by the motion sensor 18 and the operation unit 19 continues for more than or equal to a predetermined period instead of the operation of shaking the body of the mobile telephone device 1.

In Step S11, the control unit 17 determines whether or not Application A for editing text is started. If Application A is started (YES), the process proceeds to Step S13. If Application A is not started (NO), the process proceeds to Step S12.

In Step S12, the control unit 17 causes to start Application A stored in the storage unit 16. In Step S13, the control unit 17 determines which direction the body of the mobile telephone device 1 is shaken. If it is shaken toward the left, the process proceeds to Step S14. If it is shaken toward the right, the process proceeds to Step S15. If it is shaken toward a direction other than the left or the right, the process ends.

In Step S14, the control unit 17 selects the initial screen of the application displayed on the display unit 11. Here, every time the motion sensor 18 detects that the body of the mobile telephone device 1 is shaken toward the left, the control unit 17 changes the initial screens of the applications that are to be displayed on the display unit 11 in the order of: initial screen (standby screen)->memo pad application->browser application->schedule application->electronic mail application->initial screen (standby screen)->. . .

In Step S15, the control unit 17 selects the initial screen of the application displayed on the display unit 11. Here, every time the motion sensor 18 detects that the body of the mobile telephone device 1 is shaken toward the right, the control unit 17 changes the initial screens of the applications that are to be displayed on the display unit 11 in the order of: initial screen (standby screen)->electronic mail application->schedule application->browser application->memo pad application->initial screen (standby screen)->. . . , that is, an order opposite to Step S14.

In Step S16, the control unit 17 displays the initial screen of the application selected in Step S14 or Step S15 on the display unit 11 (Screen D5 or D6 in FIG. 3). In Step S17, the control unit 17 determines whether or not an operation of releasing the user's finger from the surface of the display unit 11 (operation of releasing contact) is detected by the detecting unit 12. If the operation of releasing contact is detected (YES), the process proceeds to Step S18. If the operation of releasing contact is not detected (NO), processing in Step S17 is repeated again.

In Step S18, the control unit 17 sets the long press detection flag to “FALSE”. In Step S19, the control unit 17 causes to start the selected application with the input text displayed on the display unit 11 being input into the initial screen of the selected application (Screen D7 in FIG. 3).

Accordingly, by changing the initial screen of the selected application, the mobile telephone device 1 can start the selected application in a state where the text that has been input on the display unit 11 is input into the initial screen of the selected application. Therefore, in the mobile telephone device 1, it is possible to easily use the text input on the display unit 11 in an application that executes a desired function.

Next, a second embodiment according to the electronic device of the present invention will be described. With respect to the second embodiment, matters different from the first embodiment will be mainly described and identical reference numerals are assigned to similar arrangement as that of the first embodiment and description thereof will be omitted. Descriptions for the first embodiment will be applied as appropriate for matters not described for the second embodiment in particular.

### Second Embodiment

The mobile telephone device 1 according to the second embodiment is different from the first embodiment in that icons for starting the electronic mail application, the memo pad application, or the browser application are displayed on the display unit 11 instead of the initial screen of the electronic mail application, the memo pad application, or the browser application.

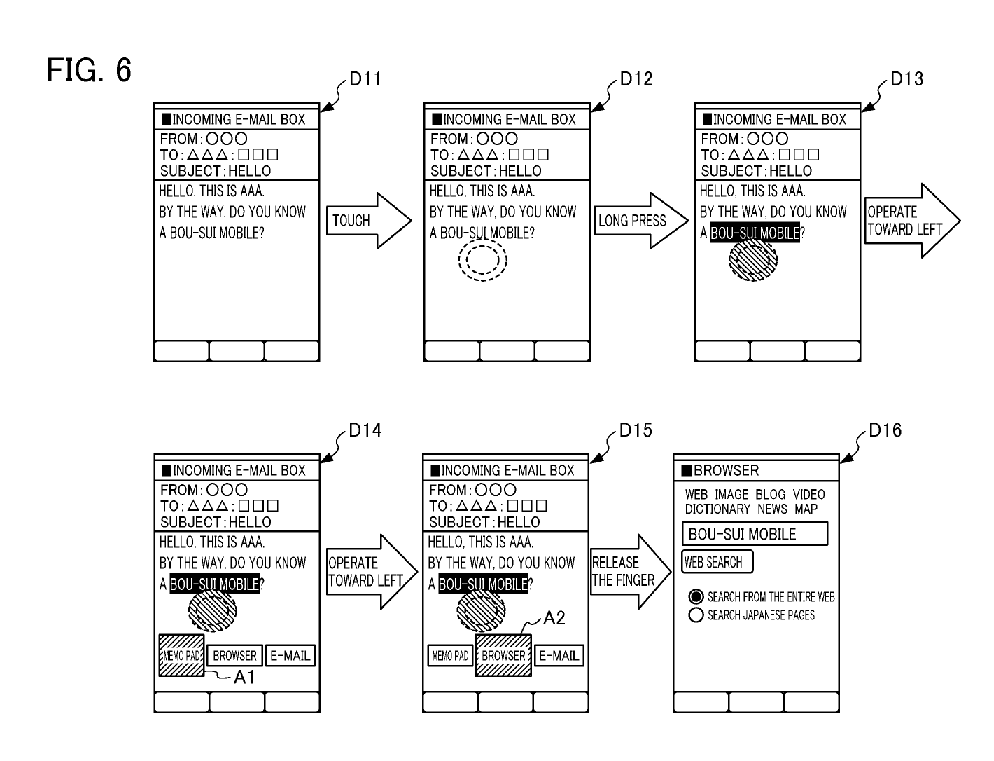

FIG. 6 is a diagram showing an example of the screen transfer displayed on the display unit 11 according to the second embodiment. In Screen D11 in FIG. 6, the control unit 17 displays a received mail on the display unit 11 by the electronic mail application. That is, the control unit 17 displays a plurality of text by the electronic mail application.

In Screen D11, that is, in a state where text is displayed on the display unit 11, the control unit 17 selects the input text “BOU-SUI MOBILE” in response to contact (long press) to the text “BOU-SUI MOBILE” being detected by the detecting unit 12 among the text displayed on Screen D11 (Screen D12). The text selected on the display unit 11 is displayed inverted (Screen D13).

In addition, the control unit 17 performs processing for starting Application A for editing input text in response to the input text “BOU-SUI MOBILE” being selected.

In Screen D13, when an operation (first operation) to shake the body of the mobile telephone device 1 toward the left when seeing the display unit 11 from the front is detected by the motion sensor 18, the control unit 17 causes to select an icon A1 (first image) of the memo pad application corresponding to the memo pad application (first function) among icons corresponding to a plurality of applications (a plurality of functions), respectively, stored in the storage unit 16 (Screen D14).

More specifically, when the operation of shaking the body of the mobile telephone device 1 toward the left is detected by the motion sensor 18, the control unit 17 causes to select the icon A1 for starting the memo pad application by, for example, a cursor, in a state where the display in the screen of the electronic mail application is maintained (Screen D14).

In Screen D14, the control unit 17 continues the state where the input text “BOU-SUI MOBILE” is selected in Screen D13 and causes to display only the selected input text “BOU-SUI MOBILE” on the display unit 11. In addition, in Screen D14, when the state where the input text “BOU-SUI MOBILE” is selected is continuing, the control unit 17 does not cause to start the memo pad application and continues the state where the icon A1 of the memo pad application is selected.

Thereafter, in Screen D14, when an operation of shaking toward the left is detected again by the motion sensor 18, the control unit 17 causes to select an icon A2 (second image) of the browser application corresponding to the browser application different from the memo pad application instead of the icon A1 among the icons corresponding to the plurality of applications, respectively (Screen D15).

More specifically, when the operation of shaking toward the left is detected again by the motion sensor 18, the control unit 17 changes from the icon A1 to the icon A2 of the browser application corresponding to the start of the browser application and continues the state where the icon A2 is selected (Screen D15).

In Screen D15, the control unit 17 continues the state where the input text “BOU-SUI MOBILE” is selected in Screen D13 and causes to display only the selected input text “BOU-SUI MOBILE” on the display unit 11. In addition, in Screen D15, when the state where the input text “BOU-SUI MOBILE” is selected is continuing, the control unit 17 may cause to continue the state where the icon A2 of the browser application is selected without causing to start the browser application, or may cause to start the browser application and cause to continue the state where the icon A2 of the browser application is selected.

Next, in Screen D15, when release of the contact to the input text “BOU-SUI MOBILE” with the user's finger is detected by the detecting unit 12, that is, when the operation (second operation) of releasing the user's finger from the surface of the display unit 11 is detected by the detecting unit 12, the control unit 17 causes to start the browser application by inputting the input text “BOU-SUI MOBILE” displayed on the display unit 11 into a search box in the initial screen of the browser application (Screen D16).

In addition, in Screen D15, when the state where an operation is not detected continues for more than or equal to a predetermined time period instead of detecting the operation (second operation) of releasing the user's finger from the surface of the display unit 11 by the detecting unit 12, the control unit 17 may cause the browser application to start by inputting the input text “BOU-SUI MOBILE” displayed on the display unit 11 into a search box in the initial screen of the browser application (Screen D16).

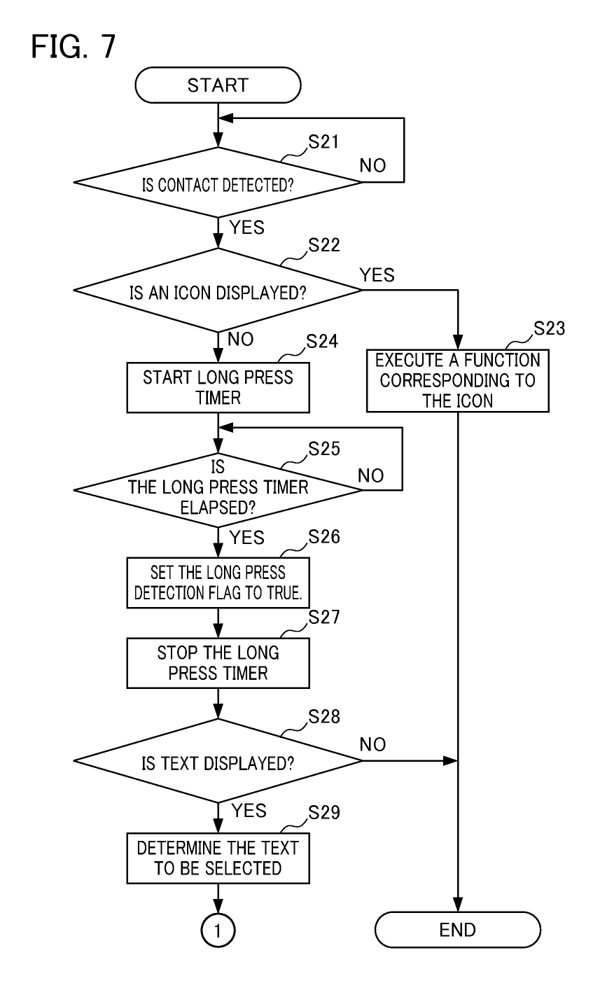

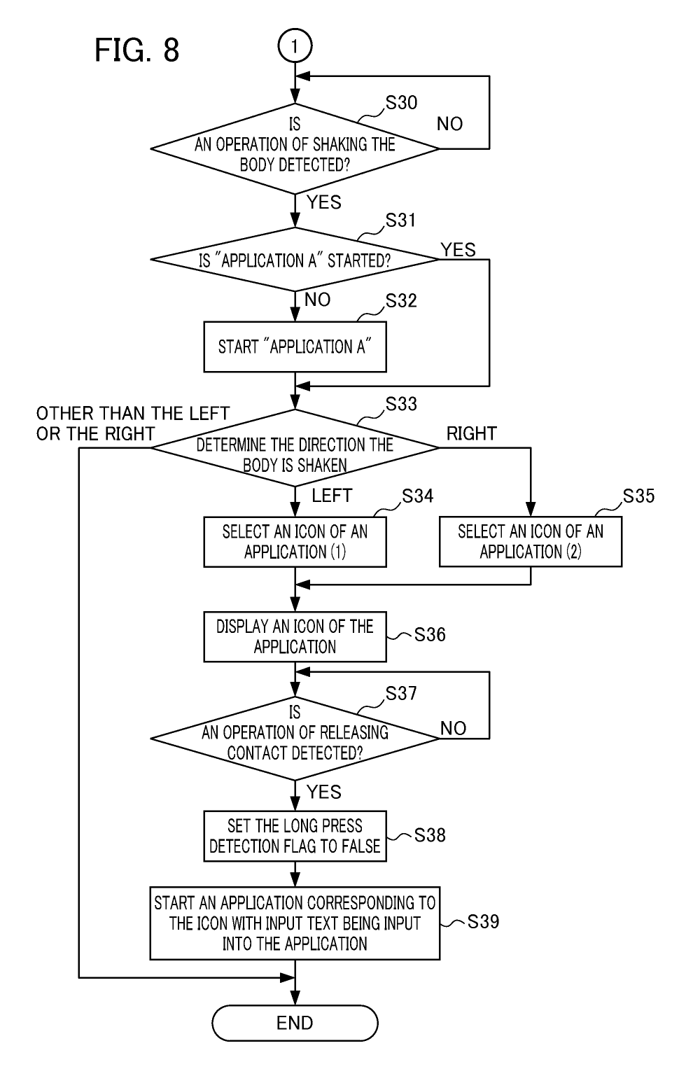

FIGS. 7 and 8 are flow charts showing internal processing of the example shown in FIG. 6. It should be noted that it is assumed that text is displayed on the display unit 11 by an application that can input text. In Step S21, the control unit 17 determines whether or not contact to the display unit 11 with the user's finger is detected by the detecting unit 12. If the contact is detected (YES), the process proceeds to Step S22. If the contact is not detected (NO), processing in Step S21 is repeated again.

In Step S22, the control unit 17 determines whether or not an icon is displayed on a location where contact is detected by the detecting unit 12. If an icon is displayed on the location where the contact is detected (YES), the process proceeds to Step S23. If an icon is not displayed on the location where the contact is detected (NO), the process proceeds to Step S24.

In Step S23, the control unit 17 executes the function associated with the icon displayed on the location where the contact is detected in Step S22 and ends the process. In Step S24, the control unit 17 starts measuring time by starting the long press timer.

In Step S25, the control unit 17 determines whether or not the contact to the display unit 11 detected by the detecting unit 12 has continued for a predetermined time period, that is, the control unit 17 determines whether or not the long press timer is elapsed. If the long press timer is elapsed (YES), the process proceeds to Step S26. If the long press timer is not elapsed (NO), processing in Step S25 is repeated again.

In Step S26, the control unit 17 sets the long press detection flag to “TRUE”. In Step S27, the control unit 17 stops the long press timer. In Step S28, the control unit 17 determines whether or not text is displayed on the location where the long press is detected on the display unit 11. If the text is displayed (YES), the process proceeds to Step S29. If the text is not displayed (NO), the process ends.

In Step S29, the control unit 17 determines the text to be selected in a unit of sentence (or a unit of word or a unit of character) and causes to display the selected text inversely.

In Step S30, the control unit 17 determines whether or not the operation of shaking the body of the mobile telephone device 1 is detected by the motion sensor 18. If the operation of shaking the body of the mobile telephone device 1 is detected (YES), the process proceeds to Step S31. If the operation of shaking the body of the mobile telephone device 1 is not detected (NO), processing in Step S30 is repeated again. It should be noted that, in Step S30, instead of the operation of shaking the body of the mobile telephone device 1, the control unit 17 may use as the condition a situation where the state where the operation is not detected by the motion sensor 18 and the operation unit 19 continues for more than or equal to a predetermined period.

In Step S31, the control unit 17 determines whether or not Application A for editing text is started. If Application A is started (YES), the process proceeds to Step S33. If Application A is not started (NO), the process proceeds to Step S32.

In Step S32, the control unit 17 causes to start Application A stored in the storage unit 16. In Step S33, the control unit 17 determines which direction the body of the mobile telephone device 1 is shaken. If it is shaken toward the left, the process proceeds to Step S34. If it is shaken toward the right, the process proceeds to Step S35. If it is shaken toward a direction other than the left or the right, the process ends.

In Step S34, the control unit 17 selects an icon of an application that is to be displayed on the display unit 11. Here, every time the motion sensor 18 detects that the body of the mobile telephone device 1 is shaken toward the left, the control unit 17 changes the icon of the application that is to be selected in the order of: initial screen (standby screen)->icon A1 of the memo pad application->icon A2 of the browser application->icon A3 of the schedule application->icon A4 of the electronic mail application->initial screen (standby screen)->. . .

In Step S35, the control unit 17 selects the icon of the application intending to display on the display unit 11. Here, every time the motion sensor 18 detects that the body of the mobile telephone device 1 is shaken toward the right, the control unit 17 changes icons of the applications that are to be selected in the order of: initial screen (standby screen)->icon A4 of the electronic mail application->icon A3 of the schedule application->icon A2 of the browser application->icon A1 of the memo pad application->initial screen (standby screen)->. . . , that is, in the order opposite to Step S32.

In Step S36, the control unit 17 causes to select the icon of the application selected in Step S34 or Step S35 with the cursor or the like (Screen D15 in FIG. 6). In Step S37, the control unit 17 determines whether or not the operation of releasing the user's finger from the surface of the display unit 11 (operation of releasing contact) is detected by the detecting unit 12. If the operation of releasing contact is detected (YES), the process proceeds to Step S38. If the operation of releasing contact is not detected (NO), processing in Step S37 is repeated again.

In Step S38, the control unit 17 sets the long press detection flag to “FALSE”. In Step S39, the control unit 17 causes to input the input text displayed on the display unit 11 in the initial screen of the application associated with the selected icon and start the application (Screen D16 in FIG. 6).

### Third Embodiment

The mobile telephone device 1 according to the third embodiment is different from the first embodiment in that, if the operation unit 19 is operated in a state where a standby screen is displayed on the display unit 11, characters and numbers assigned to the operation unit 19 are respectively input and displayed on the display unit 11.

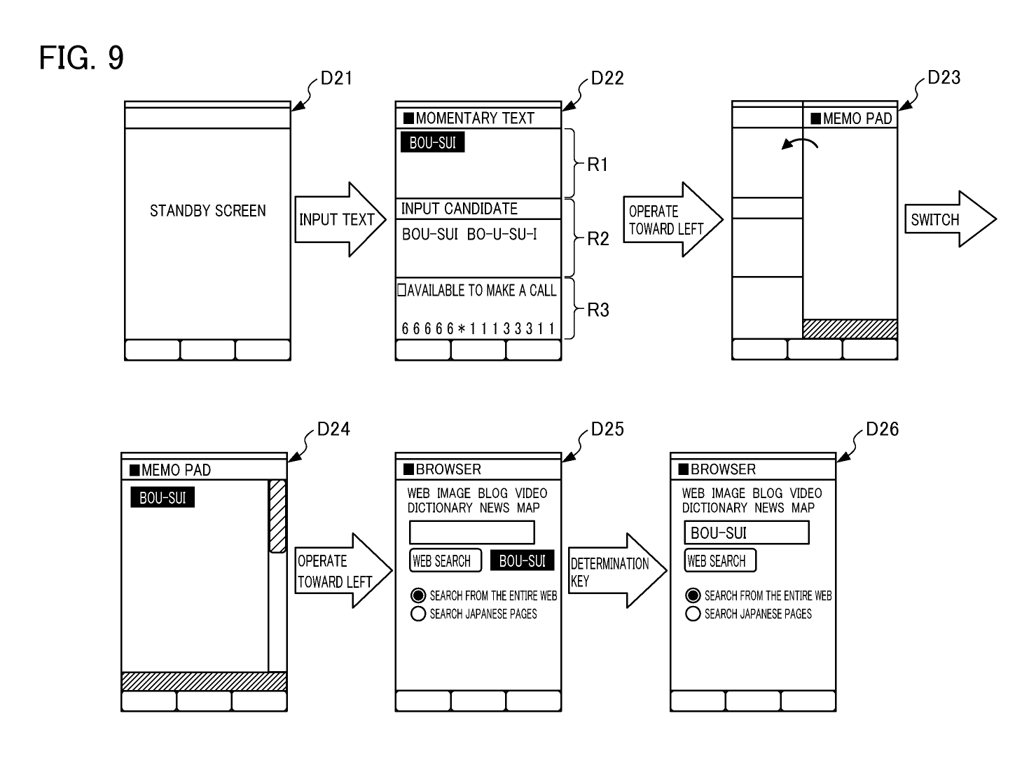

FIG. 9 is a diagram showing an example of the screen transfer displayed on the display unit 11 according to the third embodiment. In the state where a standby screen (Screen D21) is displayed on the display unit 11, when one of the operation keys is operated among the operation keys constituting the operation unit 19, the control unit 17 causes to input both the number and the character that are assigned to the operated operation key and display them on the display unit 11.

In the state where a standby screen D21, which serves as an initial screen, is displayed, when one of the operation keys is operated among the operation keys constituting the operation unit 19, the control unit 17 performs processing for starting Application A for editing input text and causes to display (input) numbers “66666*11133311” assigned to the operation keys on Region R3 by Application A and display (input) text “BO-U-SU-I (“waterproof” in primitive hiragana characters)” assigned to the operation keys on Region R1. In addition, the control unit 17 causes to display conversion candidates of the input text “BO-U-SU-I”, that is, “BOU-SUI (“waterproof” in kanji characters)” and “BO-U-SU-I” (Screen D22).

It should be noted that, in the state where a standby screen D21 is displayed as the initial screen, when the input text “BO-U-SU-I” is input by operations using the operation keys, the control unit 17 may cause to input only the text “BO-U-SU-I” associated with the operation keys and display it on Region R1 of the display unit 11. In addition, Region R1 displayed on the upper region of the display unit 11 is a region for displaying text mainly, Region R2 displayed on the middle region of the display unit 11 is a region for displaying conversion candidates mainly, and Region R3 displayed on the lower region of the display unit 11 is a region for displaying numbers mainly.

In Screen D22, input text “BO-U-SU-I” is selected in response to “BO-U-SU-I” being selected among the displayed characters and numbers. The text selected on the display unit 11 is displayed inverted (Screen D22).

In addition, in response to “BO-U-SU-I” being selected, the control unit 17 performs processing for starting Application A for editing the input text.

In Screen D22, when an operation (first operation) of shaking the body of the mobile telephone device 1 toward the left when seeing the display unit 11 from the front is detected by the motion sensor 18, the control unit 17 causes to display the screen (first image) of the memo pad application, which corresponds to a memo pad application (first function) among a plurality of applications (a plurality of functions) stored in the storage unit 16 (Screens D23 and D24).

More specifically, when the operation of shaking the body of the mobile telephone device 1 toward the left is detected by the motion sensor 18, the control unit 17 causes to change the screen from the screen displaying text, numbers, and conversion candidates to the initial screen of the memo pad application corresponding to the start of the memo pad application (Screen D23) and display the initial screen of the memo pad application on the display unit 11 (Screen D24).

In Screen D24, the control unit 17 causes to continue the state where the input text “BO-U-SU-I” is selected in Screen D22 and display only the selected input text “BO-U-SU-I” on the display unit 11. In addition, in Screen 24, when the state where the input text “BO-U-SU-I” is selected is continuing, the control unit 17 causes to display only the initial screen of the memo pad application on the display unit 11 without starting the memo pad application.

Then, in Screen D24, when the operation of shaking toward the left is detected again by the motion sensor 18, the control unit 17 causes to display the initial screen (second image) of the browser application corresponding to the browser application, which is different from the memo pad application, among a plurality of applications instead of the initial screen of the memo pad application (Screen D25).

More specifically, when the operation of shaking toward the left is detected again by the motion sensor 18, the control unit 17 causes to change the screen from the initial screen of the memo pad application to the initial screen of the browser application corresponding to the start of the browser application and display the initial screen of the browser application on the display unit 11 (Screen D25).

In Screen D25, the control unit 17 causes to continue the state where the input text “BO-U-SU-I” is selected in Screen D22 and display only the selected input text “BO-U-SU-I” on the display unit 11. In addition, in Screen D25, when the state where the input text “BO-U-SU-I” is selected is continuing, the control unit 17 may cause to display only the initial screen of the browser application on the display unit 11 without starting the browser application, or may cause to display the initial screen of the browser application on the display unit 11 by starting the browser application.

Next, in Screen D25, when a determination key that is a part of the operation unit 19 is operated, the control unit 17 causes to input “BO-U-SU-I” displayed on the display unit 11 into a search box in the initial screen of the browser application and starts the browser application (Screen D26).

As described above, according to the third embodiment, the mobile telephone device 1 can start an application in a state where text input on the display unit 11 is input into the memo pad application or the browser application by changing the screen from the standby screen to the initial screen of the memo pad application or the browser application. Therefore, the mobile telephone device 1 can easily use the text input on the display unit 11 in an application that executes a desired function.

In addition, although text input into Region R1 is used for the application that executes a desired function in the example in FIG. 9, the control unit 17 may change the order of changing the initial screen of the application in accordance with the determination result by determining whether the user is inputting a character or a number based on the character input into Region R1 and the number input into Region R3.

For example, when text input into Region R1 matches with the text stored by the dictionary database of the storage unit 16, the control unit 17 determines that the user is inputting text, and when the operation of shaking the body of the mobile telephone device 1 toward the left is detected by the motion sensor 18, the control unit 17 changes the screen to the initial screen of an application that mainly uses text (for example, memo pad application).

Meanwhile, when text input into Region R1 does not match with the text stored by the dictionary database of the storage unit 16, the control unit 17 determines that the user is inputting a number, and when the operation of shaking the body of the mobile telephone device 1 toward the left is detected by the motion sensor 18, the control unit 17 changes the screen to the initial screen of the application that mainly uses numbers (for example, calculator application). Thereby, since the mobile telephone device 1 determines whether the user is inputting text or a number and changes the order of changing the initial screen of application according to the determination result, it is possible to further improve the operativity. In addition, the user may select with the cursor or the like which of the input character or the number the user uses.

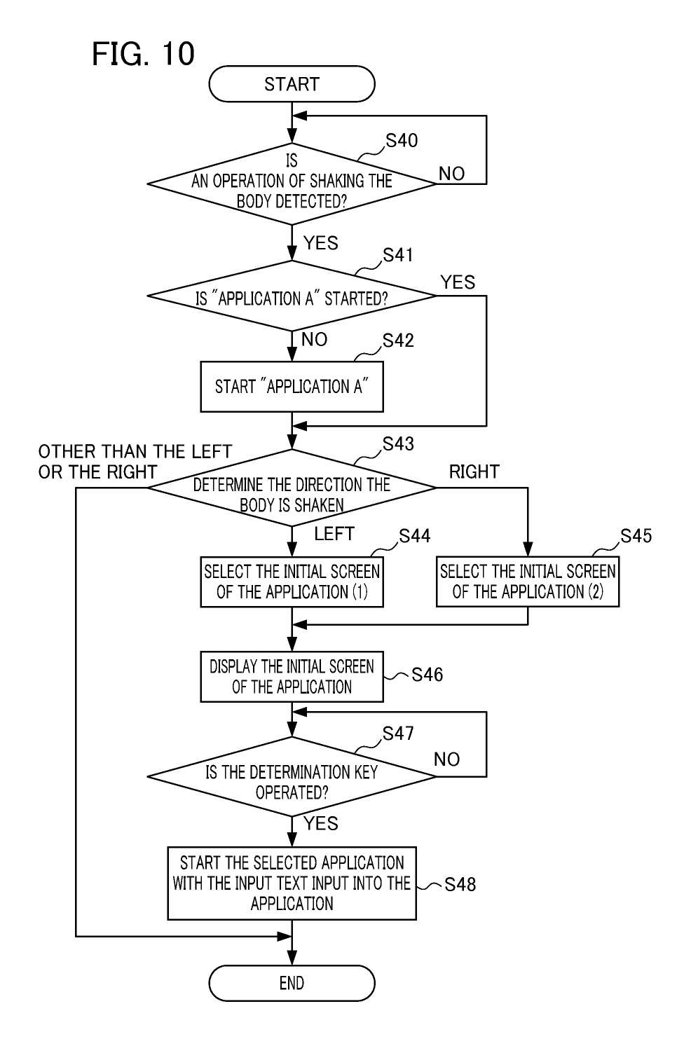

FIG. 10 is a flow chart showing internal processing of the example shown in FIG. 9. It should be noted that it is assumed that a standby screen is displayed on the display unit 11. In Step S40, the control unit 17 determines whether or not the operation of shaking the body of the mobile telephone device 1 is detected by the motion sensor 18. If the operation of shaking the body of the mobile telephone device 1 is detected (YES), the process proceeds to Step S41. If the operation of shaking the body of the mobile telephone device 1 is not detected (NO), processing in Step S40 is repeated again. It should be noted that, in Step S40, instead of the operation of shaking the body of the mobile telephone device 1, the control unit 17 may use as a condition a situation where the state where the operation is not detected by the motion sensor 18 and the operation unit 19 continues more than or equal to a predetermined period.

In Step S41, the control unit 17 determines whether or not Application A for editing text is started. If Application A is started (YES), the process proceeds to Step S43. If Application A is not started (NO), the process proceeds to Step S42.

In Step S42, the control unit 17 causes to start Application A stored in the storage unit 16. In Step S43, the control unit 17 determines which direction the body of the mobile telephone device 1 is shaken. If it is shaken toward the left, the process proceeds to Step S44. If it is shaken toward the right, the process proceeds to Step S45. If it is shaken toward a direction other than the left or the right, the process ends.

In Step S44, the control unit 17 selects the initial screen of the application displayed on the display unit 11. Here, every time the motion sensor 18 detects that the body of the mobile telephone device 1 is shaken toward the left, the control unit 17 changes the initial screens of the applications that are to be displayed on the display unit 11 in the order of: initial screen (standby screen)->memo pad application->browser application->schedule application->electronic mail application->initial screen (standby screen)->. . .

In Step S45, the control unit 17 selects the initial screen of the application displayed on the display unit 11. Here, every time the motion sensor 18 detects that the body of the mobile telephone device 1 is shaken toward the right, the control unit 17 changes the initial screens of the applications that are to be displayed on the display unit 11 in the order of: initial screen (standby screen)->electronic mail application->schedule application->browser application->memo pad application->initial screen (standby screen)->. . . , that is, the order opposite to Step S44.

In Step S46, the control unit 17 causes to display the initial screen of the application selected in Step S44 or Step S45 on the display unit 11 (Screen D24 or D25 in FIG. 9). In Step S47, the control unit 17 determines whether or not the determination key, which is a part of the operation unit 19, is operated. If the determination key is operated (YES), the process proceeds to Step S48. If the determination key is not operated (NO), processing in Step S47 is repeated again.

In Step S48, the control unit 17 causes to input the input text displayed on the display unit 11 into the initial screen of the selected application and start the selected application (Screen D26 in FIG. 9).

Although the embodiments of the present invention are described above, the present invention is not limited to the embodiments described above and may be modified suitably. In addition, the mobile telephone device 1 is described as an electronic device in the embodiments described above and is applicable to other electronic devices. For example, the electronic device of the present invention may be a digital camera, a PHS (registered trademark: Personal Handy phone System) device, a PDA (Personal Digital Assistant), a portable navigation device, a personal computer, a notebook PC, and a portable gaming device.

### EXPLANATION OF REFERENCE NUMERALS

1 MOBILE TELEPHONE DEVICE (ELECTRONIC DEVICE)
10 TOUCH PANEL (OPERATION UNIT)
11 DISPLAY UNIT
12 DETECTING UNIT
17 CONTROL UNIT

1. An electronic device comprising:
a display unit which displays images corresponding to a plurality of functions capable of inputting text; and
a control unit which, when a first operation is detected in a state where a first image corresponding to a first function among the plurality of functions is displayed or selected, causes to display or select a second image corresponding to a second function that is different from the first function among the plurality of functions instead of the first image; and wherein
in a state where the second image is displayed or selected, when a second operation different from the first operation is detected or a state where an operation is not detected continues for more than or equal to a predetermined time period, the control unit starts the second function with input text being input into the second function.

2. The electronic device according to claim 1 further comprising an operation unit, wherein
the input text is text displayed on the display unit immediately before the first image is displayed or selected.

3. The electronic device according to claim 1, wherein when the first operation is detected in a state where a first screen corresponding to the start of the first function is displayed on the display unit as the first image, the control unit causes to display a second screen corresponding to the start of the second function on the display unit as the second image, and
in a state where the second screen is displayed, when the second operation is detected or a state where an operation is not detected continues for more than or equal to a predetermined time period in a state where the second screen is displayed, the control unit causes to start the second function with the input text being input into the second function.

4. The electronic device according to claim 1, wherein
when the first operation is detected in a state where a first icon for starting the first function is selected as the first image, the control unit causes to select a second icon for starting the second function as the second image, and
in a state where the second icon is selected, when the second operation is detected or a state where an operation is not detected continues for more than or equal to a predetermined time period, the control unit causes to start the second function with the input text being input into the second function.

5. The electronic device according to claim 1, wherein
in a state where the second image is displayed or selected, the control unit causes to start the second function only when the second operation is detected or a state where an operation is not detected continues for more than or equal to a predetermined time period.

6. The electronic device according to claim 1, wherein
the first operation is an operation of shaking a body of the electronic device toward a predetermined direction, and
the control unit causes to change an order of displaying the first image and the second image on the display unit according to the direction the body of the electronic device is shaken.

7. The electronic device according to claim 1, wherein
the first operation is an operation of sliding the display unit, and
the control unit causes to change an order of displaying the first image and the second image on the display unit according to the direction the display unit is slid.

8. The electronic device according to claim 2, wherein
the operation unit includes a plurality of operation keys to which a character and a number are assigned to one operation key, and
in a state where a standby screen is displayed on the display unit, when one of the operation keys is operated among the plurality of operation keys, the control unit causes to respectively input the character and the number assigned to the operation key and display the character and the number on the display unit, and change an order of displaying the first image and the second image on the display unit according to which of the displayed text or number is input as the input text.

9. A method for controlling an electronic device comprising:
a step of displaying or selecting a first image corresponding to a first function among a plurality of functions;
a step which, when a first operation is detected, displays or selects a second image corresponding to a second function that is different from the first function among the plurality of functions instead of the first image; and
a step which, in a state where the second image is displayed or selected, when a second operation different from the first operation is detected or a state where an operation is not detected continues for more than or equal to a predetermined time period, starts the second function with input text being input into the second function.
